(19) United States
(12) Patent Application Publication
(10) Pub. No.: US 2013/0235459 A1
(43) Pub. Date: Sep. 12, 2013

(54) OPTICAL DEVICE

(71) Applicants: Manabu Shiozaki, Yokohama-shi (JP); Hidehisa Tazawa, Yokohama-shi (JP)

(72) Inventors: Manabu Shiozaki, Yokohama-shi (JP); Hidehisa Tazawa, Yokohama-shi (JP)

(73) Assignee: SUMITOMO ELECTRIC INDUSTRIES, LTD., Osaka-shi, Osaka (JP)

(21) Appl. No.: 13/883,537

(22) PCT Filed: Oct. 31, 2011
(86) PCT No.: PCT/JP2011/075100

§ 371 Date: May 24, 2013

(30) Foreign Application Priority Data
Nov. 5, 2010 (JP) 2010-248254

(51) Int. Cl. G02B 5/18

(52) U.S. Cl. CPC G02B 5/18
USPC 359/569

(57) ABSTRACT

An optical device 1 comprises an optical I/O unit 10, a transmissive diffraction grating 21, a lens 30, and a mirror array 40. The transmissive diffraction grating 21 has gratings, each extending along an x axis, formed at a fixed period, wavelength-splits the light received from the input port, and outputs wavelength-split light components. The transmissive diffraction grating 21 is rotatable about a predetermined axis. The transmissive diffraction grating 21 outputs the wavelength light components into directions which correspond to the respective wavelengths and are perpendicular to the rotary axis. The lens 30 focuses the wavelength light components wavelength-split and output by the transmissive diffraction grating 21 at respective positions different from each other.

### TECHNICAL FIELD

The present invention relates to an optical device.

### BACKGROUND ART

An optical device usable as any of optical multiplexers, optical demultiplexer, wavelength selective switches, and the like is disclosed in Patent Literature 1. In the optical device described in the literature, light received in an input port is split in terms of wavelengths by a reflective diffraction grating, the reflective diffraction grating outputs wavelength light components into respective directions corresponding to their wavelengths, and the wavelength light components output from the reflective diffraction grating are focused on positions different from each other by a condenser optical system. A plurality of mirrors configured to vary the reflection directions are disposed at the positions at which the wavelength light components are focused by the condenser optical system, so that the light components having reached the mirrors are reflected thereby, so as to travel the condenser optical system and reflective diffraction grating and then exit from any of output ports.

An example of the light into such an optical device is one in which wavelength light components of the ITU grid are multiplexed. The arrangement pitch of a plurality of mirrors is designed according to wavelengths of the ITU grid, the focal length of the condenser optical system, the grating period of the reflective diffraction grating, the angle at which light is incident on the reflective diffraction grating, and the like. Adjusting the direction of the reflected light in each mirror can configure each of wavelength components exit from which of a plurality of output ports.

When any of the angle at which the light is incident on the reflective diffraction grating, the grating period of the reflective diffraction grating, and the focal length of the condenser optical system is different from their designed values in such an optical device, the arrangement pitch of positions at which the wavelength light components are focused by the condenser optical system differs from that of the plurality of mirrors. As a result, the transmission characteristic of the optical device deteriorates. Patent Literature 1 discloses an invention intended to solve such a problem.

The optical device disclosed in Patent Literature 1 has a plurality of lenses having different focal lengths as a condenser optical system, while at least one of the lenses is movable in parallel to an optical axis direction. Adjusting the position of this lens is assumed to enable the arrangement pitch of the positions at which the wavelength light components are focused by the condenser optical system to become equal to that of the plurality of mirrors, thereby inhibiting the transmission characteristic of the optical device from deteriorating.

### CITATION LIST

### Patent Literature

Patent Literature 1: Japanese Patent Application Laid-Open No. 2007-101670

### SUMMARY OF INVENTION

### Technical Problem

In the optical device disclosed in Patent Literature 1, for example, the condenser optical system has two lenses with a gap of 20 mm therebetween and a combined focal length of 100 mm, in which the lens on the mirror array side has a focal length which is 10 times that of the lens on the reflective diffraction grating side and is movable in parallel in the optical axis direction. For correcting an error of 1% in the arrangement pitch of the positions at which the wavelength light components are focused by the condenser optical system at this time, the lens on the mirror array side may be moved by about 12 mm.

Moving the lens by 12 mm, however, shifts its focusing position by about 2 mm in the optical axis direction from the mirror array, thereby causing a loss due to defocusing. For eliminating this loss, it is necessary to move the mirror array together with the lens or employ a complicated condenser optical system whose focusing position is fixed even when the combined focal length changes. In either case, the optical device disclosed in Patent Literature 1 will complicate its structure.

For resolving the problem mentioned above, it is an object of the present invention to provide an optical device which can easily adjust the arrangement pitch of positions at which wavelength light components are focused by a condenser optical system to a predetermined pitch.

### Solution to Problem

The optical device of the present invention comprises (1) a wavelength branching unit including a transmissive diffraction grating rotatable about a predetermined axis, the wavelength branching unit configured to split light received from an input port into wavelength light components and output said wavelength right components to respective directions that are corresponding to wavelengths thereof and are perpendicular to the predetermined axis; (2) a condenser optical system configured to focus the wavelength light components received from the wavelength branching unit on positions different from each other; and (3) an optical element array including a plurality of optical elements disposed at the focusing positions of said wavelength light components focused by the condenser optical system.

The optical device of the present invention may be constructed such that the wavelength branching unit includes a plurality of transmissive diffraction gratings, of which the transmissive diffraction grating which is movable about the predetermined axis is located farthest from the condenser optical system in terms of optical path. The optical device of the present invention may also be constructed such that the wavelength branching unit includes a plurality of transmissive diffraction gratings, of which the transmissive diffraction grating which is movable about the predetermined axis is located closest to the condenser optical system in terms of optical path. In the optical device of the present invention, the predetermined axis may pass through a position where the light received from the input port reaches. The optical element array may transmit or reflect the light having reached each optical element and cause the transmitted or reflected light to exit from an output port. The optical element array may include a mirror configured to reflect the light having reached the mirror and vary a direction of the reflected light so that the reflected light travels the condenser optical system and wavelength branching unit and then exits from the output port.

### Advantageous Effects of Invention

The optical device of the present invention can easily adjust the arrangement pitch of positions at which wavelength light components are focused by a condenser optical system to a predetermined pitch.

### BRIEF DESCRIPTION OF DRAWINGS

FIG. 1 is a structural diagram of the optical device in accordance with a first embodiment;

FIG. 2 is a structural diagram of the optical device in accordance with a second embodiment; and

FIG. 3 is a structural diagram of the optical device in accordance with a third embodiment.

### DESCRIPTION OF EMBODIMENTS

In the following, embodiments of the present invention will be explained in detail with reference to the drawings. In the explanation of the drawings, the same constituents will be referred to with the same signs while omitting their overlapping descriptions.

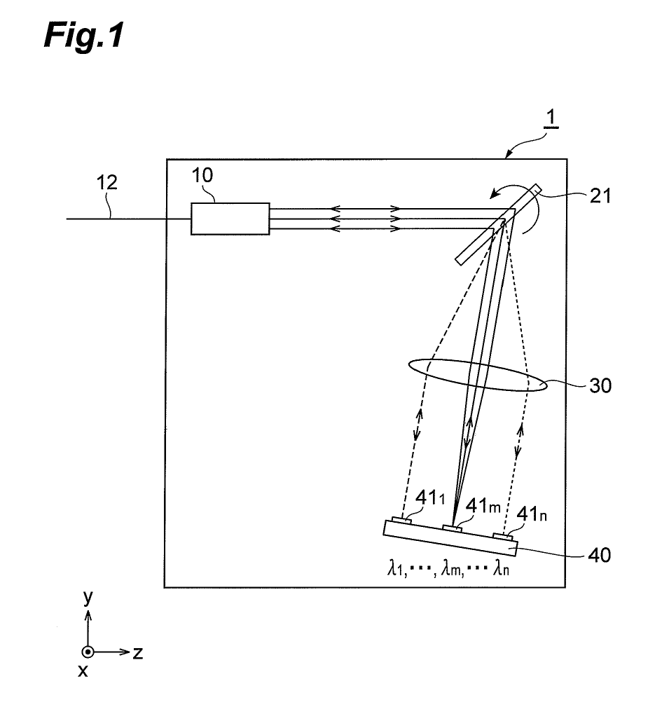

FIG. 1 is a structural diagram of the optical device in accordance with the first embodiment. FIG. 1 illustrates an xyz orthogonal coordinate system for convenience of explanation. This optical device 1 comprises an optical I/O unit 10, a transmissive diffraction grating 21, a lens 30, and a mirror array 40.

The optical I/O unit 10 includes a plurality of ports arranged in a row along the x axis. Each of the plurality of ports may be used as an input port for receiving light or an output port for outputting the light. Each of the plurality of ports is connected to its corresponding optical fiber 12 and has its corresponding collimator lens. The input port causes the collimator lens to collimate the light transmitted from the optical fiber 12 and feed the collimated light to the transmissive diffraction grating 21. The collimator lens of the output port focuses the light having arrived from the transmissive diffraction grating 21 on an end face of the optical fiber 12, so that the optical fiber 12 transmits the light. The respective optical paths between the plurality of ports included in the optical I/O unit 10 and the transmissive diffraction grating 21 are parallel to the z axis and on a common plane parallel to the xz plane.

The transmissive diffraction grating 21 serving as a wavelength branching unit has gratings. Each grating extending along the x axis, formed at a fixed period. The light received from the input port is split into wavelength light components and transmitted from the grating. The transmissive diffraction grating 21 is rotatable about a predetermined axis. The rotary axis is parallel to the x axis and preferably passes through a position where the light received from the input port reaches. The transmissive diffraction grating 21 transmits the wavelength light components into directions which correspond to the respective wavelengths and are perpendicular to the rotary axis (parallel to the yz plane). The lens 30 serving as a condenser optical system focuses the wavelength light components split by the transmissive diffraction grating 21 at respective positions different from each other.

The mirror array 40 serving as an optical element array includes a plurality of mirrors 41₁ to 41ₙ as a plurality of optical elements disposed at the respective positions of the wavelength light components focused by the lens 30. The mirrors 41₁ to 41ₙ are arranged on a line parallel to the yz plane. The mirrors 41₁, 41ₘ, and 41ₙ are disposed at the respective focusing positions of the wavelength light components having wavelengths of λ₁, λₘ, and λₙ, respectively. Each of the mirrors 41₁ to 41ₙ is configured to vary the direction of the reflected light. Each of the mirrors 41₁ to 41ₙ is preferably produced by a MEMS (Micro Electro Mechanical Systems) technique. Each of the mirrors 41₁ to 41ₙ may be a DMD (Digital Micromirror device) or DLP (Digital Light Processing).

Multiplexed light having multiple wavelengths λ₁ to λₙ received from the input port of the optical I/O unit 10, if any, in thus constructed optical device 1 is collimated from the input port and reaches the transmissive diffraction grating 21. The light having reached the transmissive diffraction grating 21 is split into wavelength light components and transmitted to directions different from each other. The wavelength light components transmitted from the transmissive diffraction grating 21 are focused by the lens 30 on positions different from each other. The mirrors 41 are arranged at the focusing positions, so that the wavelength light components focused by the lens 30 are reflected by the mirrors 41. The wavelength light components reflected by the mirrors 41 travel the lens 30 and transmissive diffraction grating 21 and then exit from any of the output ports of the optical I/O unit 10.

Since the direction of the wavelength light components reflected by the mirrors 41 are variable, which output port in a plurality of output ports output which wavelength light component can be configured. For changing the output port for a given wavelength light component, the angle of the reflecting surface of the mirror 41 located at the position where this wavelength light component is focused by the lens 30 may be changed. The angle of the reflecting surface of the mirror 41 is changed more preferably by two axes, which prevents output ports from exiting light in the process of changing, than by one axis, which may cause output ports to exit light in the process of changing.

When any of the angle at which the light is incident on the transmissive diffraction grating 21 from the input port, the grating period of the transmissive diffraction grating 21, and the focal length of the lens 30 is different from their designed values in thus constructed optical device 1, the arrangement pitch of positions at which the light components having the wavelengths λ₁ to λₙ are focused by the lens 30 differs from that of the mirrors 41₁ to 41ₙ. For solving this problem, the optical system 1 rotates the transmissive diffraction grating 21 about a rotary axis parallel to the x axis such that the arrangement pitch of positions at which the light components having the wavelengths λ₁ to λₙ are focused by the lens 30 equals that of the mirrors 41₁ to 41ₙ. Here, it is unnecessary to move the lens 30 and mirror array 40. Hence, the arrangement pitch of positions at which the light components having the wavelengths λ₁ to λₙ are focused by the lens 30 can easily be adjusted to a predetermined pitch.

Assuming that the number of gratings is 1200/mm, for example, the amount of wavelength shift that is a shift of a focused position for a wavelength light component, in a transmissive diffraction grating at the Bragg wavelength is 1/150 of the amount of wavelength shift in a reflective diffraction grating. Rotating the transmissive diffraction grating 21 by 0.3° can correct an error in dispersion or focal length by 1%, which yields a wavelength shift of 2.6 GHz. Hence, it is unnecessary for the lens 30 and mirror array 40 to move. More preferably, the amount of shift in pitch is measured at the time of mounting the mirror array, and the mirror array position is shifted beforehand by the amount of wavelength shift caused by the rotation of the diffraction grating.

When the angle of the light from the input port to the transmissive diffraction grating 21 is set such as to satisfy the Bragg condition in the transmissive diffraction grating 21 at a wavelength λₘ near the center of the input light wavelength range λ₁ to λₙ, the output direction of light component having the wavelength λₘ from the transmissive diffraction grating 21 hardly changes even when the diffraction grating 21 is rotated, whereby the position at which the light having the wavelength λₘ is focused by the lens 30 is substantially unchanged. On the other hand, the arrangement pitch of positions at which the light components having the wavelengths λ₁ to λₙ are focused by the lens 30 changes.

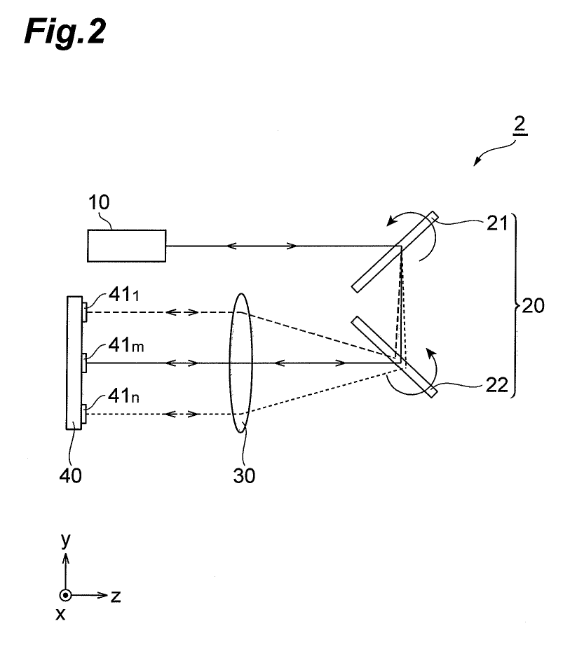

FIG. 2 is a structural diagram of the optical device in accordance with the second embodiment. FIG. 2 also illustrates an xyz orthogonal coordinate system for convenience of explanation. This optical device 2 comprises an optical I/O unit 10, a wavelength branching unit 20, a lens 30, and a mirror array 40. The optical device 2 of the second embodiment illustrated in FIG. 2 differs from the optical device 1 of the first embodiment illustrated in FIG. 1 in that it is equipped with the wavelength branching unit 20 including two transmissive diffraction gratings 21, 22.

At least one of the two transmissive diffraction gratings 21, 22 are rotatable about a predetermined axis. This rotary axis is parallel to the x axis and passes through a position where the light received from the input port reaches. The wavelength branching unit 20 including the two transmissive diffraction gratings 21, 22 transmits wavelength light components into directions which correspond to their respective wavelengths and are perpendicular to the rotary axis (parallel to the yz plane). Using the two transmissive diffraction gratings 21, 22 improves the wavelength resolution and can make the device smaller as compared with using one transmissive diffraction grating.

Preferably, the transmissive diffraction grating 21 which is movable about the predetermined axis is located farthest from the lens 30 in terms of optical path in the transmissive diffraction gratings 21, 22. This makes it possible to finely adjust the arrangement pitch of positions at which the light components having the wavelengths λ₁ to λₙ are focused by the lens 30. When the transmissive diffraction grating 22 which is movable about the predetermined axis is located closest to the lens 30 in terms of optical path in the transmissive diffraction gratings 21, 22, on the other hand, the arrangement pitch of positions at which the light components having the wavelengths λ₁ to λₙ focused by the lens 30 can be adjusted roughly.

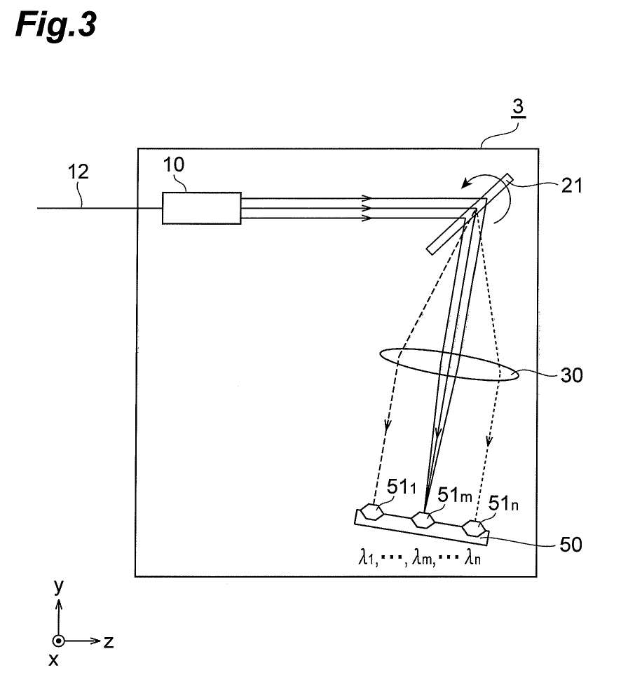

FIG. 3 is a structural diagram of the optical device in accordance with the third embodiment. FIG. 3 also illustrates an xyz orthogonal coordinate system for convenience of explanation. This optical device 3 comprises an optical I/O unit 10, a transmissive diffraction grating 21, a lens 30, and a photodiode array 50. The optical device 3 of the third embodiment illustrated in FIG. 3 differs from the optical device 1 of the first embodiment illustrated in FIG. 1 in that it comprises the photodiode array 50 in place of the mirror array 40.

The photodiode array 50 serving as an optical element array includes a plurality of photodiodes 51₁ to 51ₙ as a plurality of optical elements disposed at respective positions at which wavelength light components are focused by the lens 30. The photodiodes 51₁ to 51ₙ are arranged on a line parallel to the yz plane. The photodiodes 51₁, 51ₘ, and 51ₙ are disposed at the respective focusing positions of the light components having wavelengths of a λ₁, λₘ, and λₙ, respectively.

Multiplexed light having multiple wavelengths λ₁ to λₙ received from the input port of the optical I/O unit 10, if any, in thus constructed optical device 3 is collimated from the input port and reaches the transmissive diffraction grating 21. The light having reached the transmissive diffraction grating 21 is split into wavelength light components and transmit to directions different from each other. The wavelength light components split and transmitted by the transmissive diffraction grating 21 are focused by the lens 30 on positions different from each other. The photodiodes 51 arranged at the focusing positions receive the light components focused by the lens 30. The photodiodes 51 output electric signals having levels corresponding to the intensities of thus received light components.

When any of the angle at which the light is incident on the transmissive diffraction grating 21 from the input port, the grating period of the transmissive diffraction grating 21, and the focal length of the lens 30 is different from their designed values in thus constructed optical device 3, the arrangement pitch of positions at which the light components having the wavelengths λ₁ to λₙ are focused by the lens 30 differs from that of the photodiodes 51₁ to 51ₙ. For solving this problem, the optical system 3 rotates the transmissive diffraction grating 21 about a rotary axis parallel to the x axis such that the arrangement pitch of positions at which the light components having the wavelengths λ₁ to λₙ are focused by the lens 30 equals that of the photodiodes 51₁ to 51ₙ. Here, it is unnecessary to move the lens 30 and photodiode array 50. Hence, the arrangement pitch of positions at which the light components having the wavelengths λ₁ to λₙ are focused by the lens 30 can easily be adjusted to a predetermined pitch.

The present invention can be modified in various ways without being restricted to the above-mentioned embodiments. For example, the wavelength branching unit may include at least one rotatable diffraction grating and additionally a reflective diffraction grating.

As the optical element array including a plurality of optical elements disposed at the focusing positions of wavelength light components focused by the lens 30 serving as a condenser optical system, not only the mirror array 40 in the first and second embodiments and the photodiode array 50 in the third embodiment, but those in various modes can also be employed.

For example, a transmissive or reflective liquid crystal element array may be used as the optical element array. The reflective liquid crystal element array includes a liquid crystal element and a mirror disposed on the rear side thereof as a plurality of optical elements, respectively, while the mirror has a focusing position. A phase pattern formed by the liquid crystal element array may control the reflection direction, and a birefringent crystal placed in front of the liquid crystal element array may switch between optical paths according to the state of polarization of light controlled by the liquid crystal element array. The transmissive liquid crystal element array has a focusing position in its liquid crystal element, while a lens and an output port are arranged on the rear side thereof. A phase pattern formed by the liquid crystal element array may control light beam directions, and a birefringent crystal placed on the rear side of the liquid crystal element array may switch between optical paths according to the state of polarization of light controlled by the liquid crystal element array.

For example, an optical fiber array or an optical waveguide array formed on a substrate may also be used as the optical element array. The plurality of optical elements included in the optical element array may have equal or unequal pitches. For preventing reflected light from returning to the input port, the diffractive grating may be tilted slightly about an axis parallel to the yz plane. In this case, the demultiplexed light is not completely perpendicular to the predetermined rotary axis. However, when a diffraction grating having 1200 gratings/mm is tilted by an angle of 1°, for example, the angle of shift of light beams from a plane parallel to the yz plane is only about 4′ even between both end wavelengths in the C band (wavelength of 1530 to 1570 nm) and thus is not substantially problematic. Though the diffraction grating is preferably rotated about a predetermined axis passing through a position where the light fed to the input port reaches, because it does not change the demultiplexing position greatly, the position of the axis is not limited thereto, since the angle of rotation at the time of correcting the shift of pitch is small.

### INDUSTRIAL APPLICABILITY

The optical device of the present invention can be utilized as any of optical devices such as optical multiplexers, optical demultiplexers, and wavelength selective switches, for example.

### REFERENCE SIGNS LIST

1 to 3 . . . optical device; 10 . . . optical I/O unit; 20 . . . wavelength branching unit; 21, 22 . . . transmissive diffraction grating; 30 . . . lens; 40 . . . mirror array; 41 . . . mirror; 50 . . . photodiode array; 51 . . . photodiode

1. An optical device comprising:
a wavelength branching unit including a transmissive diffraction grating rotatable about a predetermined axis, the wavelength branching unit configured to split light received from an input port into wavelength light components and to output said wavelength light components to respective directions that are corresponding to wavelengths thereof and are perpendicular to the predetermined axis;
a condenser optical system configured to focus the wavelength light components received from the wavelength branching unit on positions different from each other; and
an optical element array including a plurality of optical elements disposed at the focusing positions of said wavelength light components focused by the condenser optical system.

2. The optical device according to claim 1, wherein the wavelength branching unit includes a plurality of transmissive diffraction gratings, the transmissive diffraction grating being movable about the predetermined axis is located farthest from the condenser optical system in terms of optical path in the plurality of transmissive diffraction gratings.

3. The optical device according to claim 1, wherein the wavelength branching unit includes a plurality of transmissive diffraction gratings, the transmissive diffraction grating being movable about the predetermined axis is located closest to the condenser optical system in terms of optical path in the plurality of transmissive diffraction gratings.

4. The optical device according to claim 1, wherein the predetermined axis passes through a position where the light received from the input port reaches.

5. The optical device according to claim 1, wherein the optical element array transmits or reflects the light having reached each optical element and causes the transmitted or reflected light to exit from an output port.

6. The optical device according to claim 5, wherein the optical element array includes a mirror configured to reflect the light having reached the mirror and to vary a direction of the reflected light so that the reflected light travels the condenser optical system and wavelength branching unit and then exits from the output port.
